(19) United States
(12) Patent Application Publication
(10) Pub. No.: US 2012/0110166 A1
(43) Pub. Date: May 3, 2012

(54) METHOD AND APPARATUS FOR GENERATING TRAFFIC

(75) Inventors: Kwangsik SHIN, Daejeon (KR); Hang Kee KIM, Daejeon (KR); Chang Joon PARK, Daejeon (KR)

(73) Assignee: Electronics and Telecommunications Research Institute, Daejeon (KR)

(21) Appl. No.: 13/218,009

(22) Filed: Aug. 25, 2011

(30) Foreign Application Priority Data
Oct. 29, 2010 (KR) 10-2010-0107228

(51) Int. Cl. G06F 15/173

(52) U.S. Cl. 709/224

(57) ABSTRACT

A method and apparatus for generating traffic generation is provided. The method for generating traffic may include: analyzing and modeling traffic generated between a server and a client and generating a packet and an inter-departure time (IDT) based on the analysis; and combining the generated packet with the generated inter-departure time by synchronization, storing the combined packet and inter-departure time in a memory, and transmitting the packet based on the inter-departure time. Therefore, it is possible to accurately model the traffic in various patterns using a method with low complexity, and thus it is possible to accurately test the server by a simpler method than the existing server testing methods.

### CROSS-REFERENCE TO RELATED PATENT APPLICATION

This application claims the benefit of Korean Patent Application No. 10-2010-0107228, filed on Oct. 29, 2010, in the Korean Intellectual Property Office, the disclosure of which is incorporated herein in its entirety by reference.

### BACKGROUND OF THE INVENTION

1. Field of the Invention

The present invention relates to a method and apparatus for generating traffic and, more particularly, to a method and apparatus for generating traffic to test a server.

2. Description of the Related Art

There are various methods for testing a server by modeling traffic generated in a network connecting the server and a client, such as a method of using a simple packet stream, a method of restoring a characteristic packet generated by a specific server application, etc.

A packet streaming method used in a network testing tool such as iperf is to test the network status by generating packets separated by a predetermined interval and is used in standard router performance tests such as those recommended in RFC 2544 and RFC 2889. Another network testing method is to model network traffic using an infinite FTP source.

Such conventional network testing methods are insufficient to perform the network test in consideration of the diversity of packet streams generated in the current network environment.

A method for testing the network by generating traffic specialized in a particular application typically calculates the characteristics of traffic generated by an actual application as statistics and tests the network in consideration of the characteristics of the traffic generated by the actual application.

Scalable URL reference generator (SURGE) is a network testing method for specialized applications, which generates HTTP workload. Such HTTP workload generation method can determine how the server and the network respond to changes in the workload. In practice, a Web server should respond to various requests received from clients, and thus the SURGE tests the network using various variables such as the file size distribution, request size distribution, embedded file references, idle periods of individual users of Web server usage, etc. to create an actual Web workload generation tool which imitates actual real users accessing the server.

Tmix is a traffic generation system used in ns-2 simulator. Tmix may be used to test the network by generating simultaneous traffic, like the traffic generated in the actual network. Moreover, Tmix is used as a traffic model of a Web service such as peer-to-peer and remote email access provided by the evolution of Web technologies, and thus it can be used as a simulator capable of testing the server in the same manner as the actual test.

Distributed Internet traffic generator (D-ITG) can simulate traffic transmitted to various transport layer protocols (such as TCP, UDP, ICMP, DNS, Telnet, VoIP, etc.).

D-ITG can accurately model the type of traffic using the packet size and inter-departure time between packets. Moreover, D-ITG can perform measurement of one-way-delay (OWD), measurement of round-trip-time (RTT), measurement of packet loss, measurement of jitter and throughput, etc.

Packet generators such as Tmix and D-ITG are to generate traffic in which the characteristics of traffic which may be generated in the traditional Internet network are reflected. However, since the traffic generated in an online game currently available has a significant interaction between data senders and receivers, the packet generated in the online game has a small size and is periodic unlike the characteristics of the traditional Internet traffic. However, the existing simulation tools for testing the server cannot generate traffic in which the characteristics of the packet generated in the online game are reflected.

### SUMMARY OF THE INVENTION

The present invention has been made in an effort to solve the above-described problems associated with prior art.

Accordingly, a first object of the present invention is to provide a method for generating traffic by reflecting the characteristics of traffic which may be generated by a specific online service.

A second object of the present invention is to provide an apparatus for generating traffic by reflecting the characteristics of traffic which may be generated by a specific online service.

According to an aspect of the present invention to achieve the first object of the present invention, there is provided a method for generating traffic, the method comprising the steps of: analyzing and modeling traffic generated between a server and a client; and generating a packet and an inter-departure time (IDT) based on the analysis, combining the generated packet with the generated inter-departure time by synchronization, storing the combined packet and inter-departure time in a memory, and transmitting the packet based on the inter-departure time.

The step of analyzing and modeling the traffic generated between the server and the client may comprise the steps of: capturing packets generated between the server and the client and analyzing characteristics of all the captured packets; and classifying the captured packets into at least two sets based on a predetermined criteria and performing traffic modeling using packet information included in at least one of the sets.

The step of capturing the packets generated between the server and the client and analyzing the characteristics of all the captured packets may comprise: analyzing information of the traffic distributed according to the size of the packets; and analyzing information of the traffic distributed according to the inter-departure time of the packets.

The predetermined criteria may be a moving average value of a traffic density.

The step of generating the packet and the inter-departure time based on the analysis, combining the generated packet with the generated inter-departure time by synchronization, storing the combined packet and inter-departure time in the memory, and transmitting the packet based on the inter-departure time may comprise: accessing a predetermined memory to determine whether the corresponding memory has a storage space; generating the packet and the inter-departure time if the memory has the storage space; and combining the generated packet with the generated inter-departure time, storing the combined packet and inter-departure time in the memory and, if the memory has no storage space, accessing other memory than the memory having no storage space to determine whether the corresponding memory has a storage space.

The step of generating the packet and the inter-departure time based on the analysis, combining the generated packet with the generated inter-departure time by synchronization, storing the combined packet and inter-departure time in the memory, and transmitting the packet based on the inter-departure time may comprise: accessing a predetermined memory to determine whether the packet and the inter-departure time are stored in the corresponding memory; extracting the packet and the inter-departure time from the memory if the packet and the inter-departure time are stored in the corresponding memory; and setting a timer for transmitting the packet based on the inter-departure time to transmit the packets at time intervals based on the inter-departure time.

The step of generating the packet and the inter-departure time based on the analysis, combining the generated packet with the generated inter-departure time by synchronization, storing the combined packet and inter-departure time in the memory, and transmitting the packet based on the inter-departure time may further comprise identifying a transport protocol, by which the packet is transmitted, to define characteristics of a socket suitable for the corresponding transport protocol.

According to another aspect of the present invention to achieve the second object of the present invention, there is provided an apparatus for generating traffic, the apparatus comprising: an analytical modeler for analyzing and modeling traffic generated between a server and a client; a packet-IDT generator for generating a packet and an inter-departure time based on traffic information provided from the analytical modeler; and a packet-IDT transmitter for transmitting the packet and the inter-departure time generated by the packet-IDT generator.

The packet-IDT generator for generating the packet and the inter-departure time based on the traffic information provided from the analytical modeler may comprise: a packet generator for generating the packet based on the traffic information provided from the analytical modeler; an inter-departure time generator for generating the inter-departure time based on the traffic information provided from the analytical modeler; and a packet-IDT combiner for combining the packet generated by the packet generator with the inter-departure time generated by the inter-departure time generator and synchronizing them.

The packet-IDT transmitter for transmitting the packet and the inter-departure time generated by the packet-IDT generator may comprise: a packet-IDT memory for storing the packet and inter-departure time combined by the packet-IDT combiner; and a timer event handler for reading the inter-departure time stored in the packet-IDT memory to determine a transmission interval of the packets.

The packet-IDT transmitter for transmitting the packet and the inter-departure time generated by the packet-IDT generator may further comprise a transport protocol analyzer for identifying a transport protocol of the packet to be extracted and transmitted from the packet-IDT memory to define characteristics of a socket for transmitting the packet.

The analytical modeler may capture the packets generated between the server and the client, analyze characteristics of all the captured packets, classify the captured packets into at least two sets based on a predetermined criteria, and perform traffic modeling using packet information included in at least one of the sets.

The analytical modeler may analyze information of the traffic distributed according to the size of the packets, analyze information of the traffic distributed according to the inter-departure time of the packets, classify the captured packets into at least two sets based on the predetermined criteria, and perform traffic modeling using the packet information included in at least one of the sets.

The predetermined criteria may be a moving average value of a traffic density.

The apparatus packet-IDT generator may access a memory for storing the packet and the inter-departure time, generate the packet and the inter-departure time if the memory has a storage space, combine the generated packet with the generated inter-departure time, store the combined packet and inter-departure time in the memory, and if the memory has no storage space, access other memory than the memory having no storage space to determine whether the corresponding memory has a storage space.

The packet-IDT transmitter may access a memory in which the packet and the inter-departure time are stored, extract the packet and the inter-departure time if the packet and the inter-departure time are stored in the memory, identify a transport protocol, by which the packet is transmitted, to define characteristics of a socket suitable for the corresponding transport protocol, and set a timer for transmitting the packet based on the inter-departure time to transmit the packets at time intervals based on the inter-departure time.

### BRIEF DESCRIPTION OF THE DRAWINGS

The above and other features and advantages of the present invention will become more apparent by describing in detail exemplary embodiments thereof with reference to the attached drawings in which:

FIG. 1 is a histogram illustrating the distribution of IDTs of Left4Dead (L4D);

FIG. 2 is a histogram illustrating the distribution of IDTs of World of Warcraft (WOW);

FIG. 3 is a histogram illustrating the distribution of packet sizes generated in L4D;

FIG. 4 is a histogram illustrating the distribution of packet sizes generated in WOW;

FIG. 5 is a conceptual diagram illustrating a traffic generator in accordance with an exemplary embodiment of the present invention;

FIG. 6 is a conceptual diagram illustrating a method for modeling and generating traffic of an online game by an analytical modeler in accordance with an exemplary embodiment of the present invention;

FIG. 7 is a flowchart illustrating a method for generating a packet by a traffic generator in accordance with an exemplary embodiment of the present invention;

FIG. 8 is a flowchart illustrating a method for generating a packet by a packet-IDT generator in accordance with an exemplary embodiment of the present invention;

FIG. 9 is a flowchart illustrating a method for transmitting a packet by a packet-IDT transmitter in accordance with an exemplary embodiment of the present invention;

FIG. 10 is a histogram illustrating the distribution of IDTs of L4D simulated by the analytical modeler in accordance with the exemplary embodiment of the present invention;

FIG. 11 is a histogram illustrating the distribution of IDTs of L4D generated by the traffic generator in accordance with the exemplary embodiment of the present invention and measured at a receiving end;

FIG. 12 is a histogram illustrating the distribution of packet sizes (byte) of L4D simulated by the analytical modeler in accordance with the exemplary embodiment of the present invention;

FIG. 13 is a histogram illustrating the distribution of packet sizes (byte) of L4D generated by the traffic generator in accordance with the exemplary embodiment of the present invention and measured at the receiving end;

FIG. 14 is a histogram illustrating the distribution of IDTs of WOW estimated using the analytical modeler in accordance with the exemplary embodiment of the present invention;

FIG. 15 is a histogram illustrating the distribution of IDTs of WOW measured at the receiving end using the traffic generator in accordance with the exemplary embodiment of the present invention;

FIG. 16 is a histogram illustrating the distribution of packet sizes of WOW estimated using the analytical modeler in accordance with the exemplary embodiment of the present invention;

FIG. 17 is a histogram illustrating the distribution of packet sizes of WOW generated by the traffic generator in accordance with the exemplary embodiment of the present invention and measured by the receiving end;

FIG. 18 is a histogram illustrating the distribution of IDTs of the traffic generated by the traffic generator without using Nagle algorithm in accordance with the exemplary embodiment of the present invention;

FIG. 19 is a histogram illustrating the distribution of packet sizes of the traffic generated by the traffic generator without using the Nagle algorithm in accordance with the exemplary embodiment of the present invention;

FIG. 20 is a Q-Q plot comparing the IDTs of the traffic generated by the traffic generator with the IDTs of the traffic generated by the analytical modeler in L4D in accordance with the exemplary embodiment of the present invention;

FIG. 21 is a Q-Q plot comparing the packet sizes of the traffic generated by the traffic generator with the packet sizes of the traffic generated by the analytical modeler in L4D in accordance with the exemplary embodiment of the present invention;

FIG. 22 is a Q-Q plot comparing the IDTs of the traffic generated by the traffic generator with the IDTs of the traffic generated by the analytical modeler in WOW when the Nagle algorithm is used in the TCP layer in accordance with the exemplary embodiment of the present invention;

FIG. 23 is a Q-Q plot comparing the packet sizes of the traffic generated by the traffic generator with the packet sizes of the traffic generated by the analytical modeler in WOW when the Nagle algorithm is used in the TCP layer in accordance with the exemplary embodiment of the present invention;

FIG. 24 is a Q-Q plot comparing the IDTs of the traffic generated by the traffic generator with the IDTs of the traffic generated by the analytical modeler in WOW when the Nagle algorithm is not used in the TCP layer in accordance with the exemplary embodiment of the present invention; and

FIG. 25 is a Q-Q plot comparing the packet sizes of the traffic generated by the traffic generator with the packet sizes of the traffic generated by the analytical modeler in WOW when the Nagle algorithm is not used in the TCP layer in accordance with the exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Exemplary embodiments in accordance with the present invention will now be described more fully with reference to the accompanying drawings. Like reference numerals in the drawings denote like elements, and thus repeated descriptions will be omitted.

Below, while the exemplary embodiments relate to a method for simulating traffic generated between an online game server and a client for convenience of description, the exemplary embodiments can be modified in various forms such as a method and apparatus for generating traffic in a technical field for testing various servers such as Web server, Enterprise Resource Planning (ERP) server, etc. rather than the game server, without departing from the spirit of the present invention, and the modifications are included within the scope of the claims.

That is, terms limited to a specific field such as an online game packet are used herein for convenience of describing the present invention, but these terms can be used for a packet generated in a network between a conventional server and a client, in which the server can be tested by the present invention.

In addition, the term “inter-departure time (IDT)” used in exemplary embodiments of the present invention means the interval at which packets are generated and has the same meaning as IDT information.

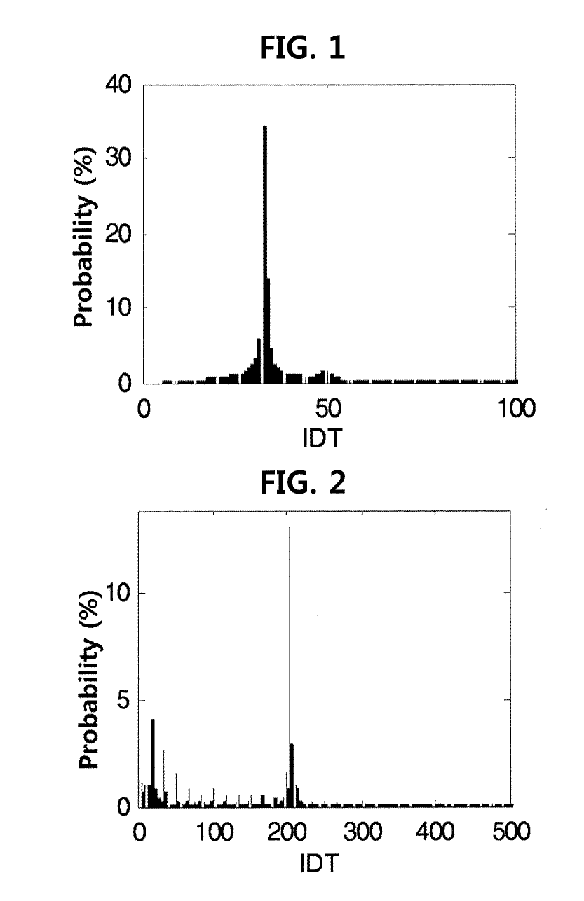

FIGS. 1 to 4 are histograms illustrating distributions of packet sizes and inter-departure times (hereinafter referred to as IDTs) which may be generated in games of various genres.

In FIGS. 1 to 4, the distributions of packet sizes and IDTs of Left4Dead (L4D) and World of Warcraft (WOW) selected from various online games are measured and illustrated in the histograms.

Left4Dead (hereinafter referred to as L4D) is a game of the first-person shooter (FPS) genre produced by Valve Corporation and World of Warcraft (hereinafter referred to as WOW) is a game of the massive multiplayer online role playing (MMORPG) genre produced by Blizzard Entertainment.

The FPS genre is a first-person shooter game developed through the point of view of a character and provides a single or team-based combat in a virtual environment. In the game of the FPS genre, UDP may be used as a transport protocol because high-speed packet processing between the client and the server is required.

MMORPG is a genre of role-playing games in which a very large number of players interact with one another and play specific roles in a virtual world.

Since the TCP has connection-oriented characteristics and high reliability for transmitted packets and can prevent error propagation for a long session, the TCP is suitable for the MMORPG genre and may be used as the transport protocol in the game of the MMORPG genre such as WOW.

FIG. 1 is a histogram illustrating the distribution of IDTs of Left4Dead (L4D).

Referring to FIG. 1, it can be seen that most IDTs of L4D have a value smaller than 50 ms.

FIG. 2 is a histogram illustrating the distribution of IDTs of WOW.

Referring to FIG. 2, it can be seen that a majority of IDTs of WOW are distributed around 200 ms different from those of L4D.

When comparing FIGS. 1 and 2, it can be seen that the IDTs of L4D are significantly shorter than those of WOW.

Unlike WOW, L4D as a game of the FPS genre is very sensitive to the interaction between the server and the client, and thus L4D requires low-latency, point-to-point communication as well as a broadcast channel to facilitate its real-time game logic. Due to the characteristics of the packets generated in the FPS genre, it is necessary to send the packets at time intervals shorter than the time required for the client to retransmit a lost packet, and thus the packet is transmitted via UDP.

That is, due to the characteristics of the FPS genre in which the interactions frequently happen between the server and the client, the IDT at which the packets are generated is shorter than the MMORPG game such as WOW.

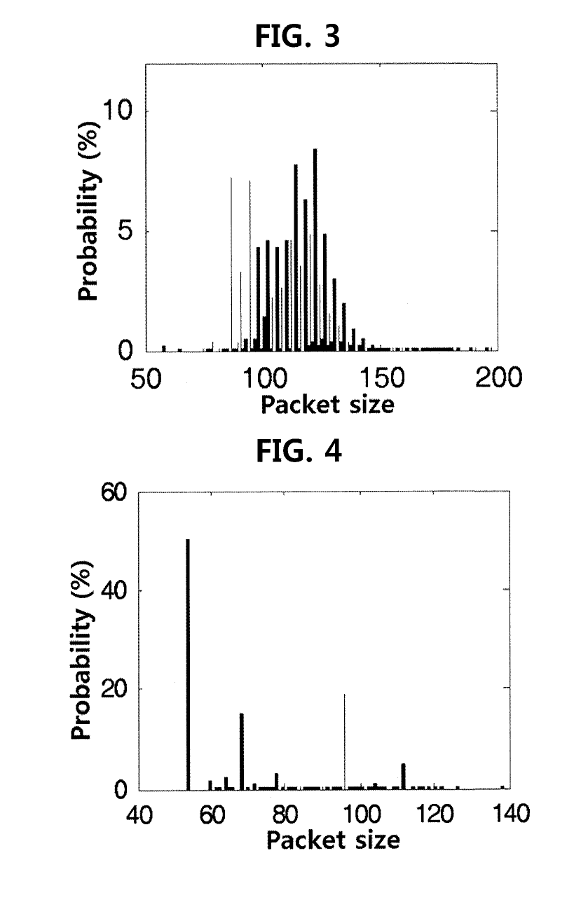

FIG. 3 is a histogram illustrating the distribution of packet sizes generated in L4D.

Referring to FIG. 3, it can be seen that the size (byte) of most of the packets generated in L4D has a value ranging from 100 bytes to 150 bytes.

FIG. 4 is a histogram illustrating the distribution of packet sizes generated in WOW.

Referring to FIG. 4, it can be seen that the size of most of the packets generated in WOW has a value ranging from 50 bytes to 70 bytes.

When comparing FIGS. 3 and 4, the packet sizes of WOW are smaller than those of L4D. While the MMORPG game such as WOW uses a TCP connection with long latency for error recovery, it uses a small packet size, thereby reducing the round trip time (RTT). Due to the characteristics of the game in the MMORPG genre, the packet size may be smaller than that of the FPS genre such as L4D.

Referring to FIGS. 1 to 4, since the packets generated in the one line games are different from each other and are significantly changed, the number of data periods to be separated may increase when a conventional network traffic modeling method, in which the traffic distribution is separated using a random distribution function for each period, is used. Thus, when the conventional network traffic modeling method is used, the complexity of network traffic modeling is increased.

According to an exemplary embodiment of the present invention, it is possible to reduce the complexity of the modeling and perform accurate modeling by employing a new method modeling method of classifying packets according to their characteristics and modeling the classified packets, unlike the conventional network modeling method.

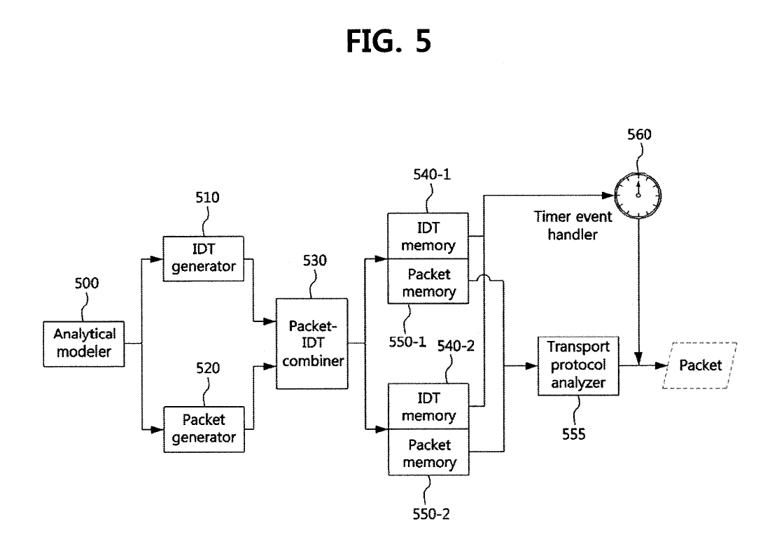

FIG. 5 is a conceptual diagram illustrating a traffic generator in accordance with an exemplary embodiment of the present invention.

Referring to FIG. 5, the traffic generator may comprise an analytical modeler 500, an IDT generator 510, a packet generator 520, a packet-IDT combiner 530, IDT memories 540-1 and 540-2, packet memories 550-1 and 550-2, a transport protocol analyzer 555, and a timer event handler 560.

While each of the above elements constituting the traffic generator is expressed as an individual element for convenience of description, each element may be implemented with a plurality of elements or the plurality of elements may be implemented as a single element unless departing from the spirit of the present invention.

Moreover, as the IDT memories 540-1 and 540-2 and the packet memories 550-1 and 550-2, a memory such as a queue, a stack, etc. may be used.

The analytical modeler 500 may model traffic of an online game.

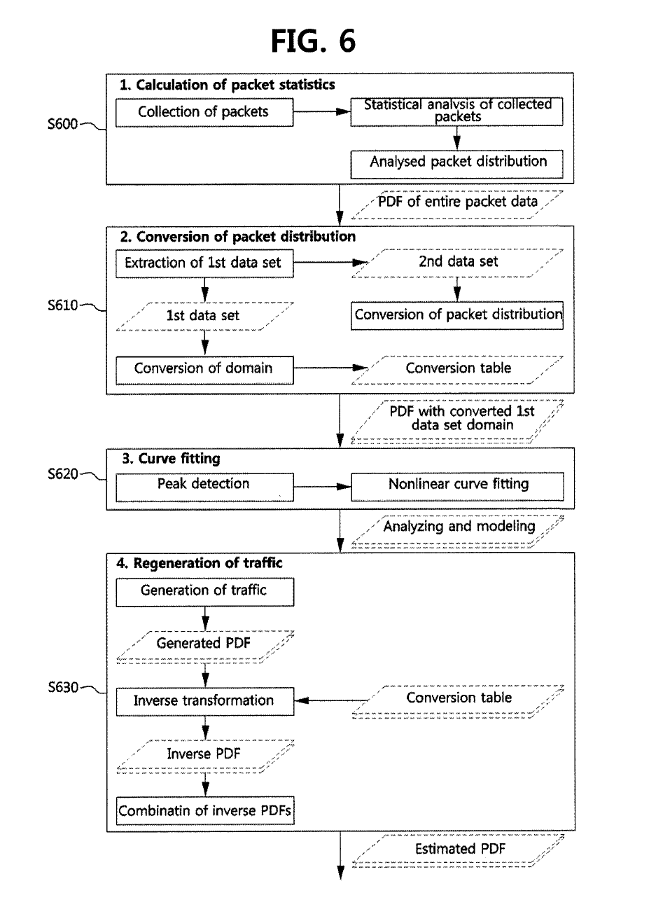

FIG. 6 is a conceptual diagram illustrating a method for modeling and generating traffic of an online game by the analytical modeler 500 in accordance with an exemplary embodiment of the present invention.

Referring to FIG. 6, the analytical modeler 500 may calculate statistics of packets measured to model the traffic of the online game (S600).

It is necessary to calculate the statistics of the measured packets in order to model the traffic of the online game. The packets generated in the online game can be collected using a traffic collection module, and the collected packets can be expressed by a predetermined function such as a probability density function (PDF). The distribution of packets generated in the majority of online games currently available is likely to be irregular, and thus the complexity for calculating the probability density function indicating all the packets generated in the online game is high and the modeling of the packets is difficult to perform.

In order to model the irregular distribution of packets by simplification, a domain of the packet distribution may be converted (S610).

The entire packet data set may be classified into a first data set satisfying a predetermined value and a second data set not satisfying the predetermined value based on the predetermined value such as a moving average value of a traffic density. When the modeling is performed using only the first data set having a predetermined value or higher, the entire packet data set can be more simplified and modeled.

When the modeling is performed using only the first data set, the second data set is removed from a primitive domain indicating the existing entire packet data set, and thus the probability density function indicating only the first data set in the primitive domain may have discontinuity. To remove the discontinuity, a method for converting the primitive domain indicating the entire packet data set into a new domain indicating only the first data set may be used.

According to the exemplary embodiment of the present invention, while the analytical modeler 500 uses only the first data set, the analytical modeler 500 may model the traffic using the second data set together with the first data set so as to perform the traffic modeling of the online game, which is close to the actual traffic modeling, if necessary.

Moreover, according to the exemplary embodiment of the present invention, while the entire packet data set may be classified into two data sets such as the first data set and the second data set based on a predetermined criteria, it is possible to classify the entire packet data set into at least two packet data sets and use the classified sets to perform the modeling, unless departing from the spirit of the present invention, thereby simplifying the traffic modeling. This method for classifying and modeling the entire packet data set into at least two packet data sets is also included in the scope of the claims.

A peak may be found from the distribution graph indicating the first data set of the first data set domain and the traffic modeling using the first data set may be performed by curve fitting (S620).

The first data set may be expressed in various types such as mathematical model, probability density function model, histogram model, etc. using the curve fitting according to the purpose of traffic analysis.

An estimated probability distribution function for testing the network load of the server may be generated based on the traffic characteristics obtained from the modeling (S630).

It is possible to perform domain conversion by generating a probability density function using the traffic generator based on the traffic characteristics obtained from the modeling and using a conversion table for expressing the probability density function indicating only the first data set in the first data set domain as the entire packet data set. Thus, it is possible to generate the estimated probability density function of the traffic generated in the online game through the above processes.

The estimated probability distribution function may be a probability density function of the IDT, packet size, etc., which can exhibit the characteristics of the traffic generated in the online game, and may also be probability density functions of other variables which can exhibit the characteristics of the traffic.

According to the exemplary embodiment of the present invention, the analytical modeler is an example for modeling the traffic of the online game, which is disclosed in Korean Patent Application No. 10-2010-0058220 entitled “Transformational approach method for modeling online game traffic”.

However, the above-mentioned method is an example of the present invention, and the present invention is not limited to the above-mentioned method but may use other methods for analyzing and modeling traffic generated on the network, unless departing from the spirit of the present invention.

The IDT generator 510 may generate the IDT such that the timer event handler 560 may adjust the interval at which the packets are generated.

The packet generator 520 may generate the packets, which may be generated in a specific game, classified according to the packet size.

The packet-IDT combiner 530 may combine the packet and the IDT since the packet is controlled by the IDT associated with the packet.

The Packet memories 550-1 and 550-2 may be implemented in the form of double buffers capable of maintaining a data block such that the timer event handler 560 and the packet generator 520 may access them at the same time.

Like the packet memories 550-1 and 550-2, the IDT memories 540-1 and 540-2 may also be implemented in the form of double buffers such they the timer event handler 560 and the IDT generator 510 may access them at the same time.

The transport protocol analyzer 555 may identify the transport protocol to use a socket suitable for the transport layer protocol and may define the characteristics of the socket for transmitting the packet.

It is possible to determine whether a specific algorithm is used by a specific protocol (e.g., TCP or UDP) for transmitting the packet by analyzing the transport protocol.

For example, in order to analyze the traffic of the MMORPG game such as WOW, the transport protocol analyzer 555 may determine that the transport layer protocol used in WOW is TCP. Thus, if the socket option is set to TCP_NODELAY based on the analysis of the transport protocol analyzer 555, the Nagle algorithm is not used when the TCP transmits the packet, and thus traffic for accurate server simulation may be generated.

The timer event handler 560 may be activated to transmit the packet when the IDT expires based on the IDT information stored in the IDT memories 540-1 and 540-2 and may initialize a timer by reading the IDTs for the next activation from the IDT memories 540-1 and 540-2 upon completion of the transmission of the packet. That is, the timer event handler 560 may adjust the interval, at which the packets are generated, based on the IDT information.

The method for generating packets using the respective elements included in the traffic generator will now be described. The traffic generated in a specific online game may be modeled by the analytical modeler 500. The packet and the IDT may be generated by the packet generator 520 and the IDT generator 510 to meet the characteristics of the packet of the online game based on the modeling results. The generated packet and the generated IDT may be combined and synchronized with each other by the packet-IDT combiner 530, and the combined packet and IDT may be stored in the IDT memories 540-1 and 540-2 and the packet memories 550-1 and 550-2. The packets stored in the packet memories 550-1 and 550-2 may be transmitted at the IDT intervals by the timer event handler 560.

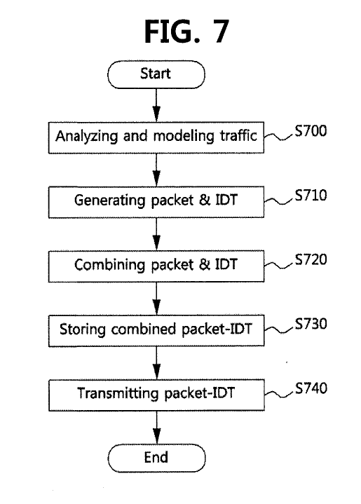

FIG. 7 is a flowchart illustrating a method for generating a packet by the traffic generator in accordance with an exemplary embodiment of the present invention.

Referring to FIG. 7, the characteristics of traffic generated between the server and the client may be analyzed and modeled (S700).

In order to analyze the characteristics of the traffic, a method for obtaining an estimated probability density function of the traffic by performing the modeling using only a part of the generated packets may be employed. However, this method is an example of the present invention, and the use of other methods for performing the modeling by analyzing the traffic generated in the network is also included within the scope of the claims, unless departing from the spirit of the present invention.

The packet and the IDT may be generated based on the characteristics of traffic analyzed by the modeling (S710).

Traffic having the same IDT distribution and packet size distribution may be generated by reflecting the characteristics of traffic obtained from the analysis.

The generated packet and the generated IDT may be combined with each other (S720).

Since the packet is transmitted upon expiration of the IDT, the packet and the IDT should be synchronized with each other and then transmitted.

The combined packet and IDT may be stored in a memory (S730).

The combined and synchronized packet and IDT may be stored in the memory until they are transmitted.

A packet-IDT stored in a queue may be transmitted (S740).

When the timer of the timer event handler is initialized based on the IDT information and the IDT expires, the same traffic as the traffic generated between the actual server and client may be generated using the method for transmitting the packet.

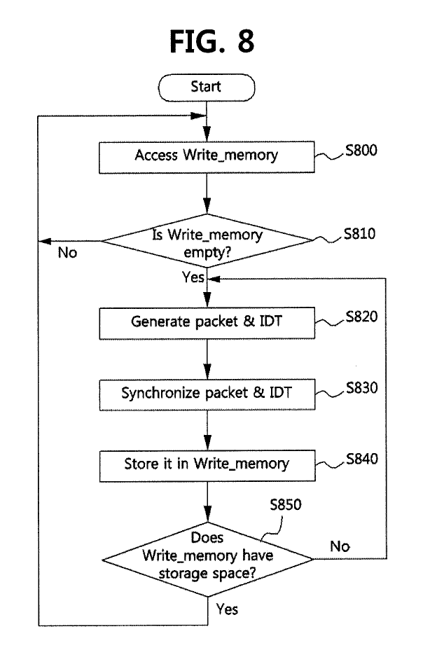

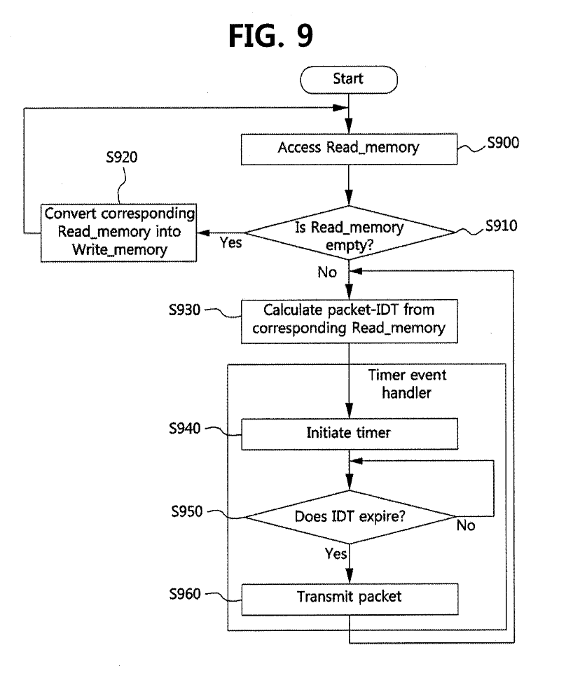

FIGS. 8 and 9 are flowcharts illustrating methods for generating a packet-IDT and transmitting the packet-IDT in accordance with an exemplary embodiment of the present invention.

The packet-IDT generator and the packet-IDT transmitter used in FIGS. 8 and 9 are illustrated as being separated from the traffic generator as a configuration for generating the packet-IDT and a configuration for transmitting the packet-IDT. For example, a configuration including the IDT generator, the packet generator, and the packet-IDT combiner may be defined as the packet-IDT generator, and a configuration including the IDT memories, the packet memories, and the timer event may be defined as the packet-IDT transmitter. These configurations are defined by classifying the respective elements included in the online game traffic generator according to their functions other than the analytical modeler for convenience of description, and these configurations may include or exclude any element or may be integrated into or separated from each other, unless departing from the spirit of the present invention.

FIG. 8 is a flowchart illustrating a method for generating a packet by the packet-IDT generator in accordance with an exemplary embodiment of the present invention.

Referring to FIG. 8, a write memory may be accessed to generate a packet-IDT (S800).

The queue used in the traffic generator is a dual queue, which may be classified into the write memory and a read memory by varying the index. The packet-IDT generator which generates the packet and IDT may store the generated queue in the queue classified as the write memory, and the packet-IDT transmitter which transmits the packet and IDT may classify the queue used to transmit the packet-IDT as the read memory and use the corresponding queue to transmit the packet-IDT. When all of the packet-IDTs stored in the read memory are transmitted, the read memory may be converted into the write memory such that the packet-IDT generated by the packet-IDT generator may be stored in the memory.

Therefore, the packet-IDT generator should select and access a write memory to store the packet-IDT generated by the packet-IDT generator.

It may be determined whether the write memory is empty (S810).

Since the memory used for the transmission by the packet-IDT transmitter corresponds to the read memory, even in the case of the write memory, the packet-IDTs generated by the packet generator and not transmitted may filled even in the write memory. The write memory fully filled with the packet-IDTs cannot store the generated packet-IDT. Thus, it may be determined whether the write memory is empty.

If the write memory is not empty, the flow may return to step S800 to find an empty write memory.

If the write memory is empty, the packet and IDT may be generated (S820).

The packet and IDT may be generated by the IDT generator and the packet generator, respectively, to store the packet and IDT in the empty write memory.

The generated packet and IDT may be combined and synchronized with each other by the packet-IDT combiner (S830).

Since the packet and DT correspond to information, which can reflect the characteristics of the generated packets to generate the packets of the online game, and should be generated as a single unit, the packet and IDT should be synchronized and combined with each other.

The synchronized packet and IDT may be stored in the write memory (S840).

The packet generated by the packet generator and the IDT generated by the IDT generator may be combined and synchronized with each other by the packet-IDT combiner, and the combined packet-IDT pair may be stored in the write memory.

It may be determined whether the write memory is full (S850).

Moreover, it may be determined whether the write memory has a space for storing the generated packet and IDT.

If the generated packet-IDT pairs are not filled in the corresponding write memory, the flow may return to step S820 to repeat the step of generating the packet and IDT, thereby filling the empty storage space of the write memory.

If the generated packet-IDT pairs are filled in the corresponding write memory, the generated packet-IDTs are not stored any longer in the write memory, and the flow may return to step S800 to find another empty write memory, thereby repeating the step of synchronizing the generated packet and IDT and storing the synchronized packet-IDT.

As a result, it is possible to prevent the packet-IDT from being excessively generated relative to the capacity of the memory by the above-mentioned packet-IDT generation step, and thus the generated packet-IDT would not disappear from the memory.

FIG. 9 is a flowchart illustrating a method for transmitting a packet by the packet-IDT transmitter in accordance with an exemplary embodiment of the present invention.

Referring to FIG. 9, the packet-IDT transmitter may designate a read memory and access the designated read memory (S900).

The packet-IDT transmitter may select one of the existing memories and transmit the packet-IDT present in the selected memory. In order to perform this transmission process, the packet-IDT transmitter may designate a memory selected by itself as the read memory and display that the packets included in the corresponding memory are being transmitted.

It may be determined whether there is a packet-IDT in the read memory designated by the packet-IDT transmitter (S910).

The read memory is a memory selected by the packet-IDT transmitter and may be empty. Thus, the packet-IDT transmitter may determine whether there is a packet-IDT to be transmitted in the selected memory.

If it is determined by the packet-IDT transmitter that the memory is empty, the index of the memory may be changed to that of the write memory such that the packet generated by the packet generator and the IDT generated by the IDT generator can be stored in the corresponding memory. Moreover, the packet-IDT transmitter may designate another memory as the read memory again to transmit the packet-IDT (S920).

The index of the empty memory may be changed to that of the write memory to store the packet-IDT generated by the packet-IDT generator such that the packet-IDT transmitter may designate the corresponding memory as the read memory and use the designated memory. Otherwise, the flow may return to step S900 to designate another memory to be used to transmit the packet-IDT as the read memory, thereby transmitting the packet using the corresponding memory.

It may be determined whether there is a packet-IDT in the read memory designated by the packet-IDT transmitter, and if it is determined that there is the packet-IDT in the corresponding read memory, the packet-IDT present in the read memory may be extracted from the memory (S930).

The IDT may be transmitted to the timer event handler based on the packet-IDT extracted from the read memory to initiate the time at which the packet is to be transmitted (S940).

In order to simulate the characteristics of the packet generated in the online game, it is necessary to generate the packet in synchronization with the corresponding IDT. Since the time interval at which the packets are to be transmitted can be determined using the IDT by which the packet generation interval is adjusted, the time interval can be adjusted by initializing the timer.

The packet-IDT transmitter may determine whether the IDT expires (S950).

Since the method for generating the online game packet in accordance with the exemplary embodiment of the present invention transmits the packet after the expiration of the IDT, it may be determined whether the IDT expires.

If the IDT expires, the packet may be transmitted (S960).

The packet which may be generated in an online game server may be generated using the method for transmitting the packet synchronized with the IDT upon expiration of the IDT.

Upon completion of the transmission of the packets, the flow may return to step S900 again to determine whether all of the packets present in the corresponding read memory are transmitted.

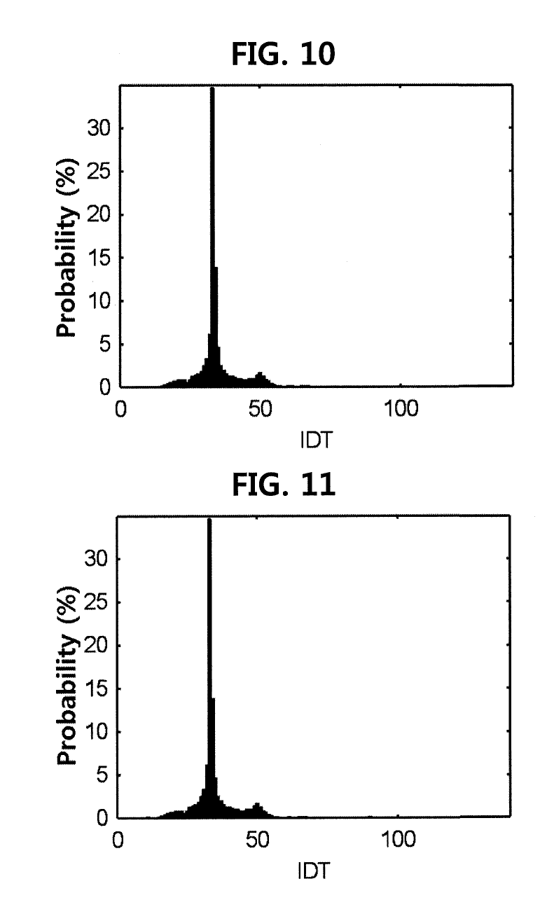

FIGS. 10 to 13 are histograms of the IDTs of traffic estimated by the analytical modeler and the IDTs of traffic generated by the traffic generator in accordance with the exemplary embodiment of the present invention.

The traffic generated by the traffic generator was measured at a receiving end for receiving the generated traffic.

FIG. 10 is a histogram illustrating the IDT distribution of L4D (Left4Dead) simulated using the analytical modeler in accordance with the exemplary embodiment of the present invention.

FIG. 11 is a histogram illustrating the IDT distribution of L4D generated by the traffic generator measured at the receiving end in accordance with the exemplary embodiment of the present invention.

When comparing FIGS. 10 and 11, the traffic generator in accordance with the exemplary embodiment of the present invention can generate traffic having an IDT distribution similar to that of an actual online game.

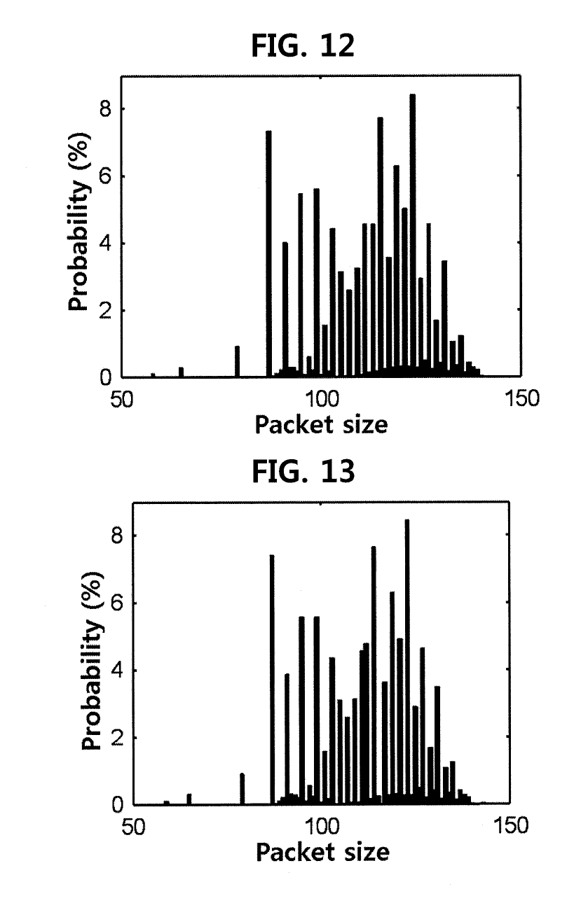

FIG. 12 is a histogram illustrating the distribution of packet sizes (byte) of L4D simulated using the analytical modeler in accordance with the exemplary embodiment of the present invention.

FIG. 13 is a histogram illustrating the distribution of packet sizes (byte) of L4D generated by the traffic generator and measured at the receiving end in accordance with the exemplary embodiment of the present invention.

When comparing FIGS. 12 and 13, the traffic generator in accordance with the exemplary embodiment of the present invention can generate traffic having a packet size distribution similar to an actual packet size distribution.

That is, according to the exemplary embodiment of the present invention, in the case of the FPS genre such as L4D, the packet and IDT generated by the traffic generator can have characteristics similar to those of the traffic generated between the server and the client of the actual online game.

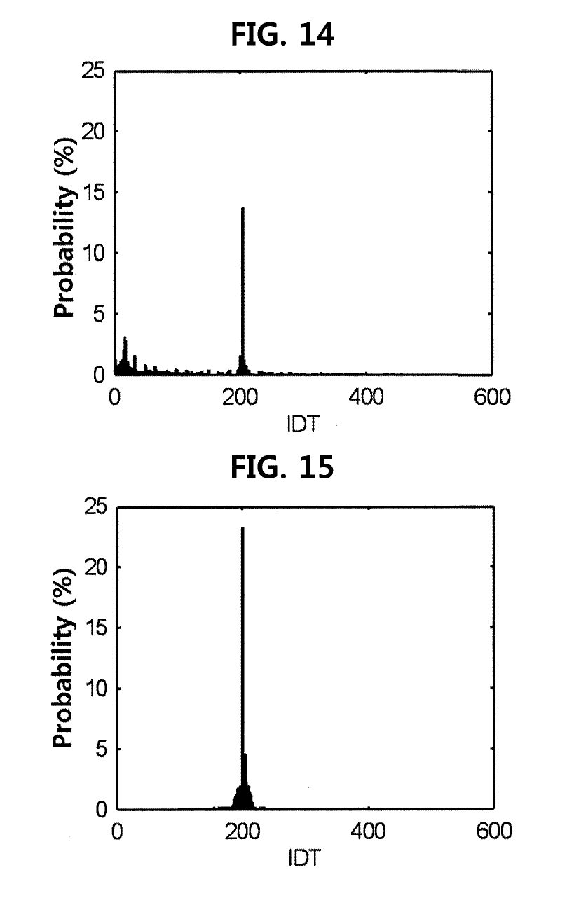

FIGS. 14 to 17 are histograms illustrating IDT distributions and packet size distributions obtained by simulating the traffic generated in the online game WOW using the analytical modeler and those obtained by the traffic generator in accordance with the exemplary embodiment of the present invention, respectively.

The traffic generated by the traffic generator was measured at the receiving end for receiving the generated traffic.

FIG. 14 is a histogram illustrating the IDT distribution of WOW estimated by the analytical modeler in accordance with the exemplary embodiment of the present invention.

FIG. 15 is a histogram illustrating the IDT distribution of WOW measured at the receiving end using the traffic generator in accordance with the exemplary embodiment of the present invention.

When comparing FIGS. 14 and 15, it can be seen that the IDT distribution of the traffic generated by the traffic generator is different from that of the traffic estimated by the analytical modeler, unlike L4D.

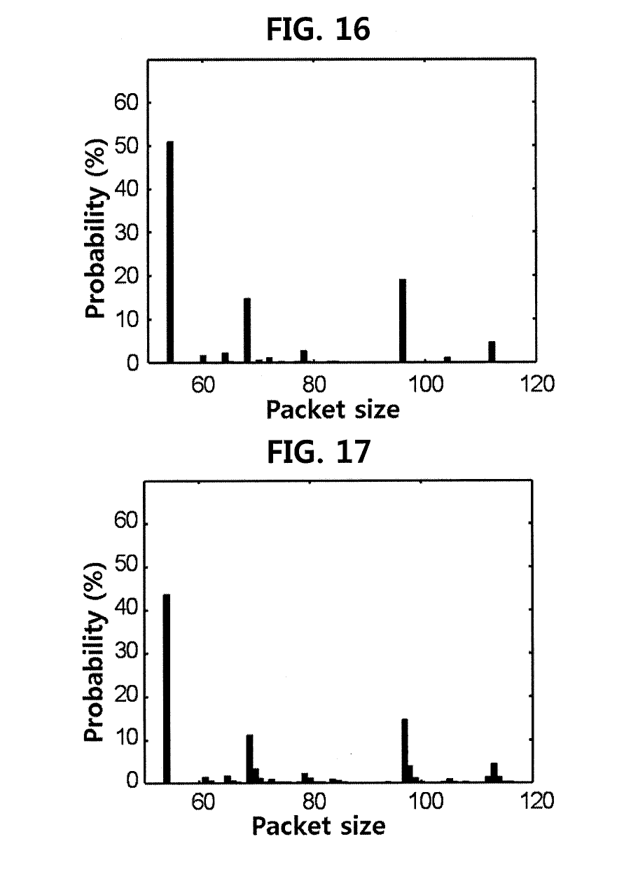

FIG. 16 is a histogram illustrating the distribution of packet sizes of WOW estimated by the analytical modeler in accordance with the exemplary embodiment of the present invention.

FIG. 17 is a histogram illustrating the distribution of packet sizes of WOW generated by the traffic generator and measured at the receiving end in accordance with the exemplary embodiment of the present invention.

When comparing FIGS. 16 and 17, it can be seen that the traffic generator in accordance with the exemplary embodiment of the present invention can generate a simulation packet having a packet size distribution slightly different from the actual packet size distribution.

Referring to FIGS. 14 to 17, it can be seen that in WOW, the traffic generated by the traffic generator and measured at the receiving end has the IDT distribution and packet sizes different from the characteristics of the traffic estimated by the analytical modeler, unlike L4D.

The difference between the traffic estimated by the analytical modeler and the traffic generated by the traffic generator and measured at the receiving end is caused by the Nagle algorithm used in TCP, a transport protocol used in the game of the MMORPG genre like WOW.

The commonly used TCP uses the Nagle algorithm which collects small packets and sends the collected packets at a time to reduce overhead due to packet headers generated when the small packets are transmitted successively. The use of the Nagle algorithm can reduce unnecessary use of the headers, which makes it possible to effectively use the network resource usage, but the delay time of each packet is increased.

Therefore, the Nagle algorithm may be deactivated by setting TCP_NODELAY of TCP socket options to prevent the delay of the packet in the game of the MMORPG genre like WOW. The traffic generator can immediately send the packet to the network by setting the TCP_NODELAY socket option without delay when the packet is transmitted from a TCP terminal.

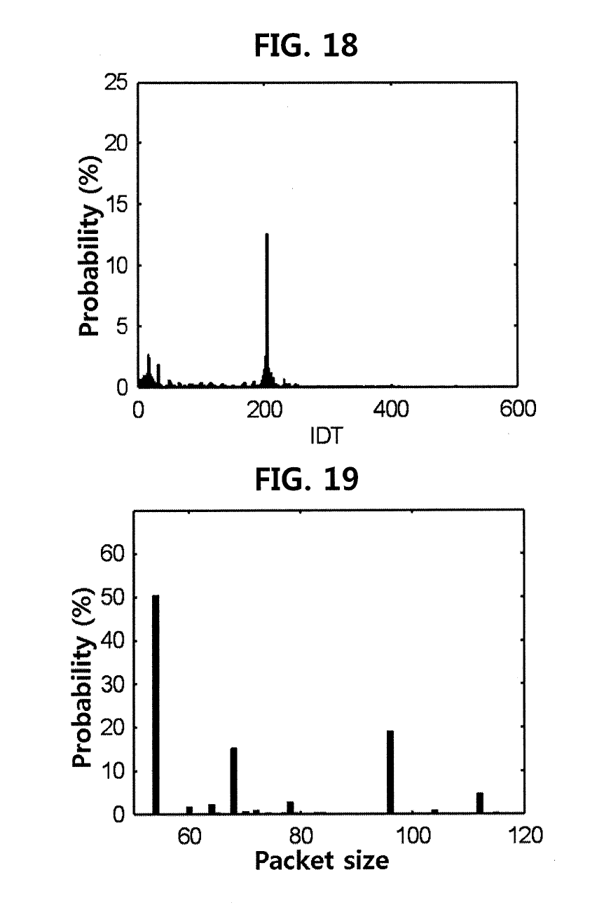

FIGS. 18 and 19 are histograms illustrating the traffic transmitted via TCP without using the Nagle algorithm in accordance with the exemplary embodiment of the present invention.

FIG. 18 is a histogram illustrating the IDT distribution of the traffic generated by the traffic generator without using the Nagle algorithm in accordance with the exemplary embodiment of the present invention.

FIG. 19 is a histogram illustrating the distribution of packet sizes of the traffic generated by the traffic generator without using the Nagle algorithm in accordance with the exemplary embodiment of the present invention.

Referring to FIGS. 18 and 19, it can be seen that when the Nagle algorithm is not used in the TCP layer, the traffic generated by the traffic generator has the same IDT distribution and pack size distribution as those of the traffic estimated by the analytical modeler.

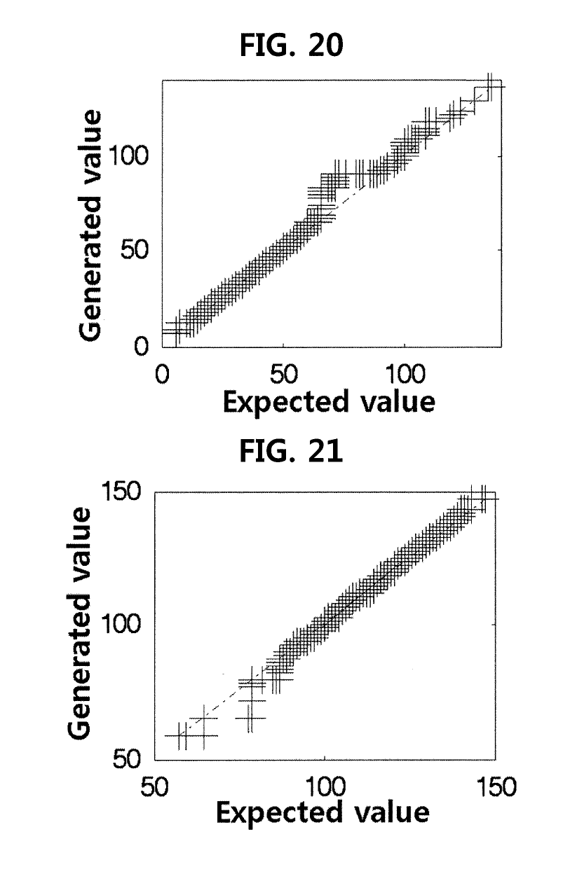

FIGS. 20 to 25 are Q-Q plots illustrating the IDTs and the packet sizes of the traffic in accordance with the exemplary embodiment of the present invention.

A Q-Q plot is a plot of the difference between an expected value and an actual value and shows the comparison between the values of the IDT and packet size generated by simulation and the values of the IDT and packet size actually generated. It can be determined that when the marks are plotted closer to a straight line, the IDT and packet size of the traffic estimated by the analytical modeler are similar to those of the traffic generated by the traffic generator and received at the receiving end.

FIG. 20 is a Q-Q plot comparing the IDT of the traffic generated by the traffic generator with the IDT of the traffic generated by the analytical modeler in L4D in accordance with the exemplary embodiment of the present invention.

FIG. 21 is a Q-Q plot comparing the packet sizes of the traffic generated by the traffic generator with the packet sizes of the traffic generated by the analytical modeler in L4D in accordance with the exemplary embodiment of the present invention.

Referring to FIGS. 20 and 21, it can be seen that the values of the IDT and packet size of the traffic estimated by the analytical modeler are almost the same as those of the traffic generated by the traffic generator.

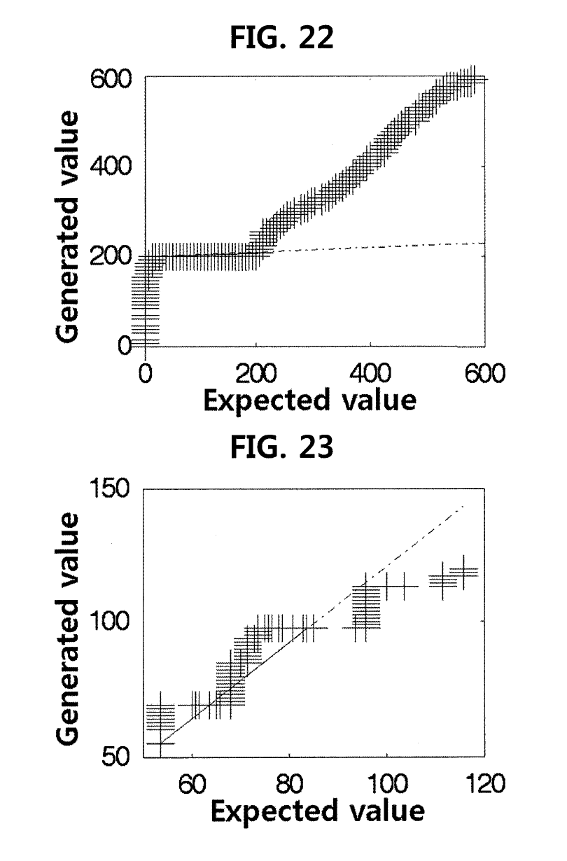

FIG. 22 is a Q-Q plot comparing the IDTs of the traffic generated by the traffic generator with the IDTs of the traffic generated by the analytical modeler in WOW when the Nagle algorithm is used in the TCP layer in accordance with the exemplary embodiment of the present invention.

FIG. 23 is a Q-Q plot comparing the packet sizes of the traffic generated by the traffic generator with the packet sizes of the traffic generated by the analytical modeler in WOW when the Nagle algorithm is used in the TCP layer in accordance with the exemplary embodiment of the present invention.

Referring to FIGS. 22 and 23, it can be seen that the values of the IDT and packet size of the traffic estimated by the analytical modeler are not identical to those of the traffic generated by the traffic generator.

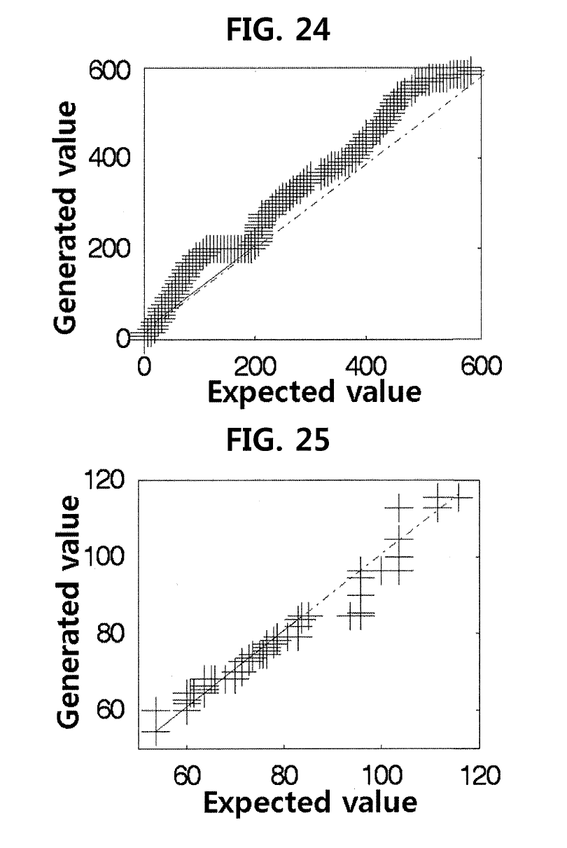

FIG. 24 is a Q-Q plot comparing the IDTs of the traffic generated by the traffic generator with the IDTs of the traffic generated by the analytical modeler in WOW when the Nagle algorithm is not used in the TCP layer in accordance with the exemplary embodiment of the present invention.

FIG. 25 is a Q-Q plot comparing the packet sizes of the traffic generated by the traffic generator with the packet sizes of the traffic generated by the analytical modeler in WOW when the Nagle algorithm is not used in the TCP layer in accordance with the exemplary embodiment of the present invention.

Referring to FIGS. 24 and 25, it can be seen that when the Nagle algorithm is not used in the TCP layer, the values of the IDT and packet size of the traffic estimated by the analytical modeler are the same with those of the traffic generated by the traffic generator, compared to FIGS. 22 and 23 using the Nagle algorithm.

As shown in FIGS. 20 to 25, it can be seen that when the method and apparatus for generating traffic in accordance with the exemplary embodiments of the present invention is used, the traffic generator can reproduce the traffic similar to that generated between the server and the client in the actual online game. Thus, when the method disclosed in the present invention is used, it is possible to accurately simulate the server traffic at a reduced complexity compared to the conventional traffic measurement method.

As described above, according to the method and apparatus for generating traffic in accordance with the exemplary embodiments of the present invention, it is possible to analyze and model the traffic, generated when a specific service is provided via a network, using a simplified method compared to the conventional method for analyzing traffic and to generate the traffic, which is similar to that generated in the network when an actual online service is provided, through the traffic generator based on the analyzed characteristics of the traffic.

Therefore, it is possible to accurately model the traffic in various patterns using a method with low complexity, and thus it is possible to accurately test the server by a simpler method than the existing server testing methods.

As above, exemplary embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

What is claimed is:

1. A method for generating traffic, the method comprising:
analyzing and modeling traffic generated between a server and a client; and
generating a packet and an inter-departure time (IDT) based on the analysis, combining the generated packet with the generated inter-departure time by synchronization, storing the combined packet and inter-departure time in a memory, and transmitting the packet based on the inter-departure time.

2. The method of claim 1, wherein the analyzing and modeling the traffic generated between the server and the client comprises:
capturing packets generated between the server and the client and analyzing characteristics of all the captured packets; and
classifying the captured packets into at least two sets based on a predetermined criteria and performing traffic modeling using packet information included in at least one of the sets.

3. The method of claim 2, wherein the capturing the packets generated between the server and the client and analyzing the characteristics of all the captured packets comprises:
analyzing information of the traffic distributed according to the size of the packets; and
analyzing information of the traffic distributed according to the inter-departure time of the packets.

4. The method of claim 2, wherein the predetermined criteria is a moving average value of a traffic density.

5. The method of claim 1, wherein the generating the packet and the inter-departure time based on the analysis, combining the generated packet with the generated inter-departure time by synchronization, storing the combined packet and inter-departure time in the memory, and transmitting the packet based on the inter-departure time comprises:
accessing a predetermined memory to determine whether the corresponding memory has a storage space;
generating the packet and the inter-departure time if the memory has the storage space; and
combining the generated packet with the generated inter-departure time, storing the combined packet and inter-departure time in the memory and, if the memory has no storage space, accessing other memory than the memory having no storage space to determine whether the corresponding memory has a storage space.

6. The method of claim 1, wherein the generating the packet and the inter-departure time based on the analysis, combining the generated packet with the generated inter-departure time by synchronization, storing the combined packet and inter-departure time in the memory, and transmitting the packet based on the inter-departure time comprises:
accessing a predetermined memory to determine whether the packet and the inter-departure time are stored in the corresponding memory;
extracting the packet and the inter-departure time from the memory if the packet and the inter-departure time are stored in the corresponding memory; and
setting a timer for transmitting the packet based on the inter-departure time to transmit the packets at time intervals based on the inter-departure time.

7. The method of claim 6, wherein the generating the packet and the inter-departure time based on the analysis, combining the generated packet with the generated inter-departure time by synchronization, storing the combined packet and inter-departure time in the memory, and transmitting the packet based on the inter-departure time further comprises identifying a transport protocol, by which the packet is transmitted, to define characteristics of a socket suitable for the corresponding transport protocol.

8. An apparatus for generating traffic, the apparatus comprising:
an analytical modeler for analyzing and modeling traffic generated between a server and a client;
a packet-IDT generator for generating a packet and an inter-departure time based on traffic information provided from the analytical modeler; and
a packet-IDT transmitter for transmitting the packet and the inter-departure time generated by the packet-IDT generator.

9. The apparatus of claim 8, wherein the packet-IDT generator for generating the packet and the inter-departure time based on the traffic information provided from the analytical modeler comprises:
a packet generator for generating the packet based on the traffic information provided from the analytical modeler;
an inter-departure time generator for generating the inter-departure time based on the traffic information provided from the analytical modeler; and
a packet-IDT combiner for combining the packet generated by the packet generator with the inter-departure time generated by the inter-departure time generator and synchronizing them.

10. The apparatus of claim 8, wherein the packet-IDT transmitter for transmitting the packet and the inter-departure time generated by the packet-IDT generator comprises:
a packet-IDT memory for storing the packet and inter-departure time combined by the packet-IDT combiner; and
a timer event handler for reading the inter-departure time stored in the packet-IDT memory to determine a transmission interval of the packets.

11. The apparatus of claim 10, wherein the packet-IDT transmitter for transmitting the packet and the inter-departure time generated by the packet-IDT generator further comprises a transport protocol analyzer for identifying a transport protocol of the packet to be extracted and transmitted from the packet-IDT memory to define characteristics of a socket for transmitting the packet.

12. The apparatus of claim 8, wherein the analytical modeler captures the packets generated between the server and the client, analyzes characteristics of all the captured packets, classifies the captured packets into at least two sets based on a predetermined criteria, and performs traffic modeling using packet information included in at least one of the sets.

13. The apparatus of claim 12, wherein the analytical modeler analyzes information of the traffic distributed according to the size of the packets, analyzes information of the traffic distributed according to the inter-departure time of the packets, classifies the captured packets into at least two sets based on the predetermined criteria, and performs traffic modeling using the packet information included in at least one of the sets.

14. The apparatus of claim 12, wherein the predetermined criteria is a moving average value of a traffic density.

15. The apparatus of claim 8, wherein the packet-IDT generator accesses a memory for storing the packet and the inter-departure time, generates the packet and the inter-departure time if the memory has a storage space, combines the generated packet with the generated inter-departure time, stores the combined packet and inter-departure time in the memory, and if the memory has no storage space, accesses other memory than the memory having no storage space to determine whether the corresponding memory has a storage space.

16. The apparatus of claim 8, wherein the packet-IDT transmitter accesses a memory in which the packet and the inter-departure time are stored, extracts the packet and the inter-departure time if the packet and the inter-departure time are stored in the memory, identifies a transport protocol, by which the packet is transmitted, to define characteristics of a socket suitable for the corresponding transport protocol, and sets a timer for transmitting the packet based on the inter-departure time to transmit the packets at time intervals based on the inter-departure time.
